(19) United States
(12) Patent Application Publication
(10) Pub. No.: US 2021/0326697 A1
(43) Pub. Date: Oct. 21, 2021

(54) CONVOLUTION OPERATION MODULE AND METHOD AND A CONVOLUTIONAL NEURAL NETWORK THEREOF

(71) Applicant: NATIONAL CHIAO TUNG UNIVERSITY, Hsinchu (TW)

(72) Inventors: Juinn-Dar HUANG, Zhubei City (TW); Yi LU, Taipei City (TW); Yi-Lin WU, Pitou Township (TW)

(73) Assignee: NATIONAL CHIAO TUNG UNIVERSITY, Hsinchu (TW)

(21) Appl. No.: 17/004,668

(22) Filed: Aug. 27, 2020

(30) Foreign Application Priority Data
Apr. 20, 2020 (TW) 109113187

(51) Int. Cl. G06N 3/08; G06F 9/30; G06F 9/54

(52) U.S. Cl. CPC G06N 3/08; G06F 9/545; G06F 9/30036

(57) ABSTRACT

A convolution operation module comprising a first memory element, a second memory element and a first operation unit is presented. The first memory element is configured to store a first part of a first row data of an array data. The second memory element is configured to store a second part of a second row data of an array data. Wherein the second row data is adjacent to the first row data in the array data and the first part and the second part have a same amount of data. The first operation unit is coupled to the first memory element and second memory element. Wherein the first operation unit integrates the first part and the second part into a first operation matrix. Wherein the first operation unit performs a convolution operation on the first operation matrix and a first kernel map to derive a first feature value.

### BACKGROUND OF THE INVENTION

### 1. Field of the Invention

The present invention generally relates a convolution operation module, a convolution operation method and a convolutional neural network thereof, in particular, a convolution operation module and detecting method to simplify the complexity of computing process.

### 2. Description of the Prior Art

Recently, artificial intelligence (AI) technologies that optimize accuracy or efficiency through deep learning has been widely used in daily life to save manpower and other resources. Inspired by bionic technologies, deep learning technologies can be implemented using artificial neural network (ANN) to achieve a learning, inducting or summary system.

Because convolution neural network (CNN) can avoid complex preprocessing procedures and take raw data directly, CNN is a more popular method among ANN methods. However, since the operation of CNN needs a huge amount of operation procedures, consumes a huge amount of hardware computing resource, and takes a long time to read/write data and fill register or memory, computing time of CNN tends to be too long.

Accordingly, developing a convolution operation module and method thereof to reduce the consumption of operation resource during a convolution operation is the biggest issue that convolutional neural network technology must overcome at present.

### SUMMARY OF THE INVENTION

One of the purposes of the present invention is providing a convolution operation module and method thereof to reduce the consumption of operation resource and the operation time during convolution operation.

One of the purposes of the present invention is providing a convolution operation module comprising a first memory element, a second memory element and a first operation unit. The first memory element is configured to store a first part of a first row data of an array data. The second memory element is configured to store a second part of a second row data of an array data. Wherein the second row data is adjacent to the first row data in the array data and the first part and the second part have a same amount of data. The first operation unit is coupled to the first memory element and second memory element. Wherein the first operation unit integrates the first part and the second part into a first operation matrix. Wherein the first operation unit performs a convolution operation on the first operation matrix and a first kernel map to derive a first feature value.

The present invention provides a convolution operation module comprising a first memory element, a second memory element, an integration element and a first operation element. The first memory element is configured to store at least a part of a first row data of an array data as a first memory data. The second memory element is configured to store at least a part of a second row data of the array data as a second memory data. Wherein the second row data is adjacent to the first row data in the array data. The integration element integrates the first part and the second part into a first operation matrix. The first operation element performs a convolution operation on the first operation matrix and a first kernel map to derive a first feature value. Wherein after the first feature value is derived, the first memory element stores at least a part of a third row data of the array data and updates the first memory data. Wherein the third row data is adjacent to the second row data in the array data. The integration element integrates the updated first memory data and the second memory data into a second operation matrix, and the first operation element performs the convolution operation on the second operation matrix and the first kernel map to derive a second feature value.

The present invention provides a convolutional neural network comprising one of the convolution operation modules mentioned above, a pooling module and a fully connected module.

The present invention provides a convolution operation method comprising: storing a first part of a first row of an array data as a first memory data; storing a second part of a second row data of the array data as a second memory data, wherein the second row data is adjacent to the first row data in the array data and the first part and the second part have a same amount of data; integrating the first memory data and the second memory data into a first operation matrix; and performing a convolution operation on the first operation matrix and a first kernel map using a first operation element to derive a first feature value.

The present invention provides a convolution operation method comprising: storing at least a part of a first row data of an array data as a first memory data; storing at least a part of a second row data of the array data as a second memory data, wherein the second row data is adjacent to the first row data in the array data; performing a convolution operation on the first operation matrix and a first kernel map using a first operation element to derive a first feature value; storing at least a part of a third row data of the array data and updating the first memory data by the part of a third row data of the array data, wherein the third row data is adjacent to the second row data in the array data; integrating the first memory data and the second memory data into a second operation matrix; and performing a convolution operation on the second operation matrix and the first kernel map using the first operation element to derive a second feature value.

Accordingly, by alternately reading/writing partial row data of the data array, the read or write time will be decreased and the amount of the reading/writing row data for one-time operation will be reduced by the integration element. Hence, the consumption of operation resource while performing convolution operation will be reduced and the operation time will be shortened.

### BRIEF DESCRIPTION OF THE DRAWINGS

FIG. 1 is a schematic view of the convolutional neural network according to an embodiment of the present invention.

FIG. 2 is an operation schematic view of the convolutional neural network according to an embodiment of the present invention.

FIG. 3 is a schematic view of the convolutional neural network having two operation elements according to an embodiment of the present invention.

FIG. 4A to FIG. 4C are schematic views of operation path according to an embodiment of the present invention.

FIG. 5 is a schematic view of deriving feature matrix according to an embodiment of the present invention.

FIG. 6 and FIG. 7 are operating schematic views of the convolution operation module having at least 3 sets of memory element according to an embodiment of the present invention.

FIG. 8A and FIG. 8B are operating schematic views of the convolution operation module having a selector to switch the reading of memory data according to an embodiment of the present invention.

FIG. 9A and FIG. 9B are operating schematic views of the convolution operation module applied to the reading of a plurality of row data and the switching of selectors according to an embodiment of the present invention.

FIG. 10 and FIG. 11 are flow charts of the convolution operation method according to an embodiment of the present invention.

### DETAILED DESCRIPTION OF THE PREFERRED EMBODIMENT

The connecting elements according to the present invention will be described in detail below through embodiments and with reference to the accompanying drawings. A person having ordinary skill in the art may understand the advantages and effects of the present disclosure through the contents disclosed in the present specification.

It should be understood that, even though the terms such as “first”, “second”, “third” may be used to describe an element, a part, a region, a layer and/or a portion in the present specification, but these elements, parts, regions, layers and/or portions are not limited by such terms. Such terms are merely used to differentiate an element, a part, a region, a layer and/or a portion from another element, part, region, layer and/or portion. Therefore, in the following discussions, a first element, portion, region, layer or portion may be called a second element, portion, region, layer or portion, and do not depart from the teaching of the present disclosure.

The terms “comprise”, “include” or “have” used in the present specification are open-ended terms and mean to “include, but not limit to.”

Unless otherwise particularly indicated, the terms, as used herein, generally have the meanings that would be commonly understood by those of ordinary skill in the art. Some terms used to describe the present disclosure are discussed below or elsewhere in this specification to provide additional guidance to those skilled in the art in connection with the description of the present disclosure.

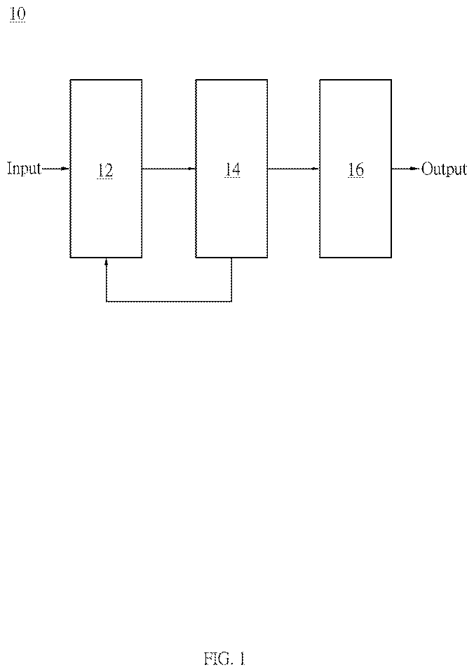

Refer to FIG. 1, the present invention provides the convolutional neural network 10 comprising the convolution operation module 12, the pooling module 14 and the fully connected module 16. More specifically, the convolutional neural network 10 can be used for operations needing comparison, such as image recognition, language processing or drug screening, but the present invention is not limited by the application scope of the convolutional neural network 10. The pooling module 14 is connected to the convolution operation module 12. The pooling module 14 is configured to reduce the data amount of result after calculation by means of downsampling and so on. However, the present invention is not limited by downsampling methods performed by the pooling module 14. The data after downsampling can be performed the convolution operation again using the convolution operation module 12 or be transmitted to the fully connected module 16. The fully connected module 16 classifies the data using non-linear methods, such as but not limited to Sigmoid, Tanh or ReLU, and outputs results to derive calculation results or comparison results. It should be noted that the convolution operation module 12, the pooling module 14 and the fully connected module 16 can be implemented by software methods or hardware methods. In addition, the convolutional neural network 10 is not limited to the structure mentioned above. Any convolutional neural networks accomplished by the convolution operation module 12 of the present invention should belong to the technical scope of the present invention.

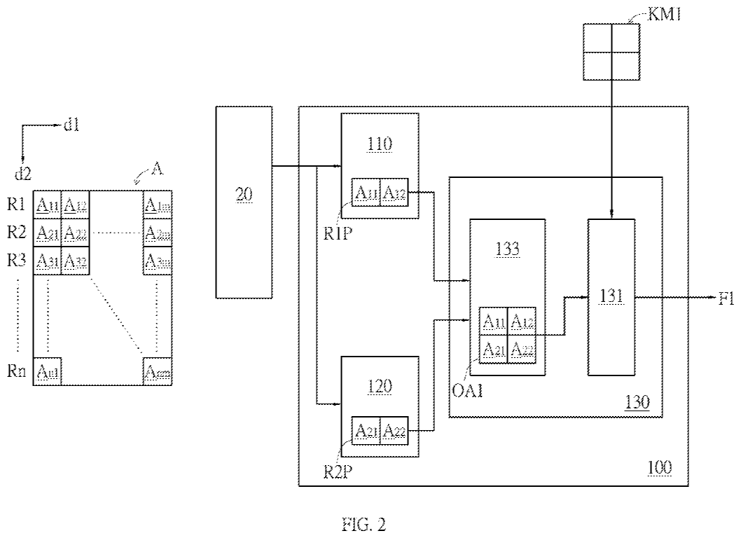

FIG. 2 shows the convolution operation module 100 according to the first embodiment of the present invention. As shown in FIG. 2, the convolution operation module 100 comprises the first memory element 110, the second memory element 120 and the first operation unit 130. The first memory element 110 and the second memory element 120 can be a hard disk, flash memory, DRAM or any register. The first memory element 110 is configured to store the first part R1P of the first row data R1 of the array data A. The second memory element 120 is configured to store the second part R2P of the second row data R2 of the array data A. It should be noted that the array data A can be but not limited to, for example, video data, image data or audio data. The array data can be stored in the external storage device 20. The array data A has a plurality of row data sequenced along the second direction d2. For example, the array data A has n rows of data R1-Rn. Please note that the sequence direction of row data (second direction d2) used in the embodiment is just for the simplicity of description; the sequence direction of row data can also be the first direction d1. The first direction d1 and the second direction d2 are, for example, orthogonal to each other in a plane. The first direction d1 and the second direction d2 can be represented as the column direction and row direction in an array. Wherein the second row data R2 is adjacent to the first row data R1 in the array data A and the first part R1P and the second part R2P have a same amount of data. For example, the first row data R1 has m number of data A₁₁-A₁ₘ and sequenced along the first direction d1, wherein m is a positive integer. Each of the first part R1P and the second part R2P has x number of data, wherein x is a positive integer larger than 1 and less than m. The first operation unit 130 is coupled to the first memory element 110 and the second memory element 120. The first operation unit 130 comprises the first operation element 131 and the integration element 133. The first operation element 131 can be a convolver. Wherein the first operation unit 130 reads the first part R1P and the second part R2P and integrates the first part R1P and the second part R2P into the first operation matrix OA1. More specifically, the integration unit 133 of the first operation unit 130 integrates the first part R1P of the first row data R1 and the second part R2P of the second row data R2 into the first operation matrix OA1. The first operation matrix OA1 is, for example, a 2×x matrix. Preferably, the first operation matrix OA1 is a square matrix, such as a 2×2 matrix. But the first operation matrix OA1 is not limited to any matrix size. Wherein the first operation element 131 performs a convolution operation on the first operation matrix and the first kernel map KM1 to derive the first feature value F1. The first feature value F1 is, for example, the correlation or the similarity between the first operation matrix OA1 and the first kernel map KM1. Preferably, the size of first kernel map KM1 is the same as the size of the first operation matrix OA1.

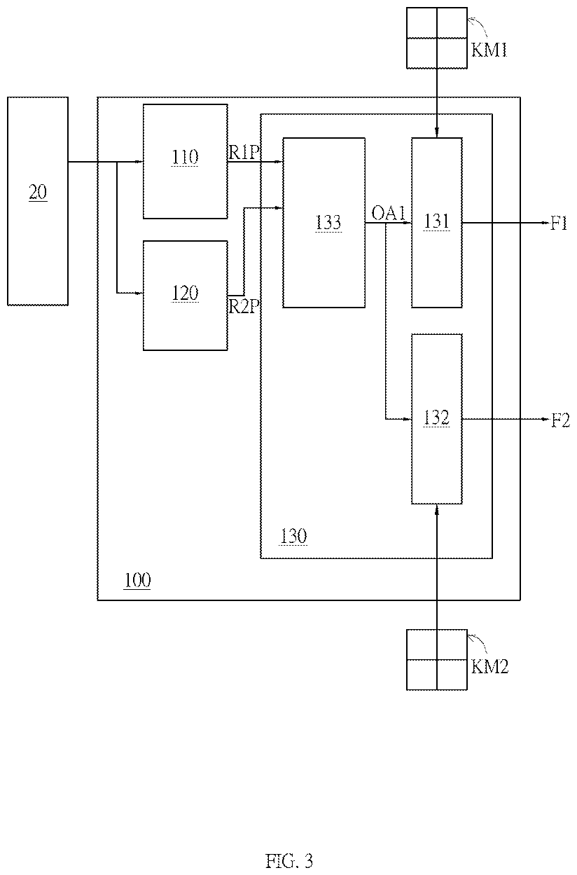

In an embodiment, other feature values can be derived by a plurality of operation elements performing the convolution operation on the first operation matrix OA1 and other kernel maps. As shown in FIG. 3, the first operation unit 130 further comprises the second operation element 132 coupled to the integration element 133. Wherein the second operation element 132 performs the convolution operation on the first operation matrix OA1 and the second kernel map KM2 to derive the second feature value F2. More specifically, the second kernel map KM2 and the first kernel map KM1 correspond to two different comparison features respectively. By means of the embodiment, a plurality of feature values can be derived in a writing procedure.

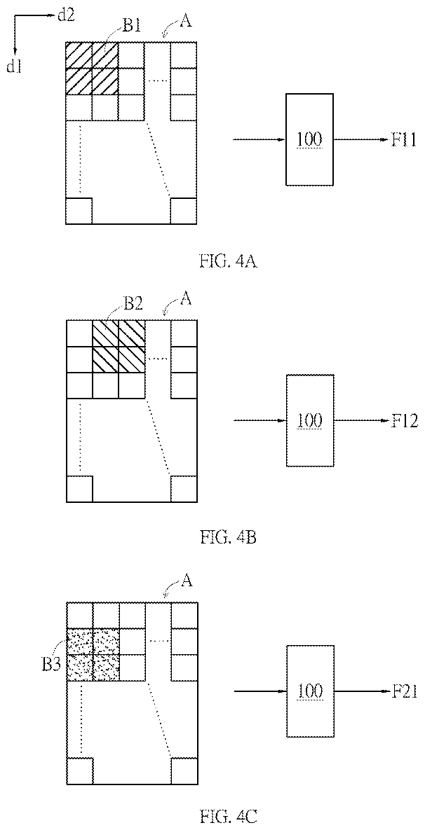

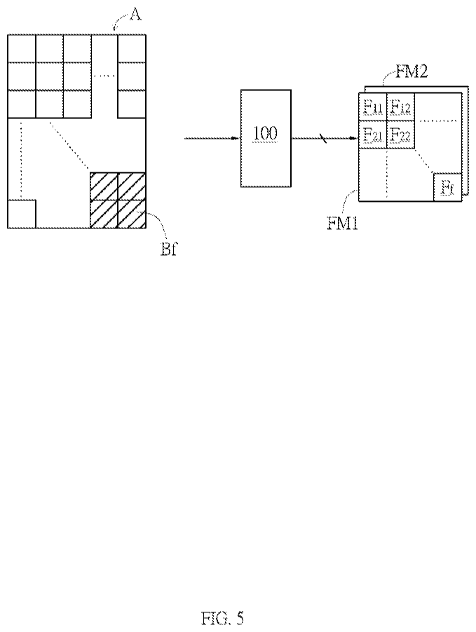

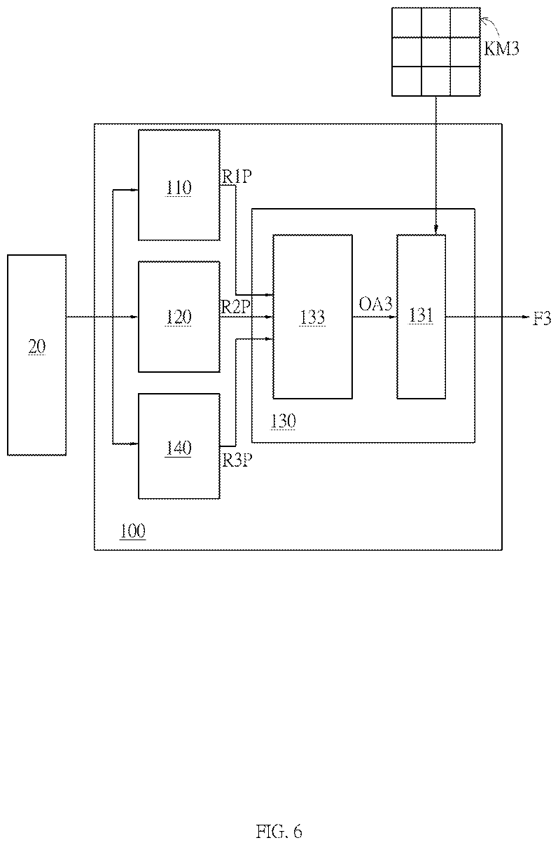

Refer to FIG. 4A to FIG. 4C. After the feature value F11 corresponding to operation matrix OA1 (the first block B1 in the array data A) is derived, one would, for example, shift to the second block B2 along the first direction d1 (shown in FIG. 4B) to find the next block to be calculated by the convolution operation module 100 and calculate the feature value F12, or shift to the third block B3 along the second direction d2 (shown in FIG. 4C) to calculate the feature value F21. The definition of the block is, for example, a part which is going to be performed the convolution operation in the array data A. More specifically, when the block to be calculated in the array data A shifts from the first block B1 to the second block B2 along the first direction d1, the first memory element 110 stores the first updated part R1P′ which is partially overlapping with or adjacent to the first part data R1P in the first row data R1. For example, when the first part R1P is data A11 and A12, the first updated part R1P′ can be data A12 and A13, or data A13 and A14. The second memory element 120 stores the second updated part R2P′ which partially overlaps with the second part data R2P or adjacent to the second part data R2P in the second row data R2. For example, when the second part R2P is data A21 and A22, the second updated part R2P′ can be data A22, and A23, or data A23 and A24. When the block to be calculated in the array data A shifts from the first block B1 to the third block B3 along the second direction d2, one of the first memory element 110 and the second memory element 120 stores the second part R2P of the second row data R2, and the other stores the third part R3P of the third row data R3 which is adjacent to the second row data R2. Wherein the second part and the third part have the same amount of data. It should be noted that the shifting stride of the block is not limited to 1. The shifting stride of the block can be larger than 1; preferably, the shifting stride of the block can be 1 to x−1. In should be noted that the method of integration and the procedure for deriving the feature value is similar to the embodiment mentioned above, and we will not repeat it here. Next, as shown in FIG. 5, the convolution operation module 100 performs the convolution operation to sequentially derive the feature values F11, which corresponds to the first block B1 of the data array A, to Ff, which corresponds to the block Bf and is the last block in the data array A. The feature values F1 to Ff will be integrated into the first feature matrix FM1 according to the operating sequence and the stride directions. In addition, for multiple kernel maps KM1 and KM2, the first feature matrix FM1 and the second feature matrix FM2 or more can be respectively produced.

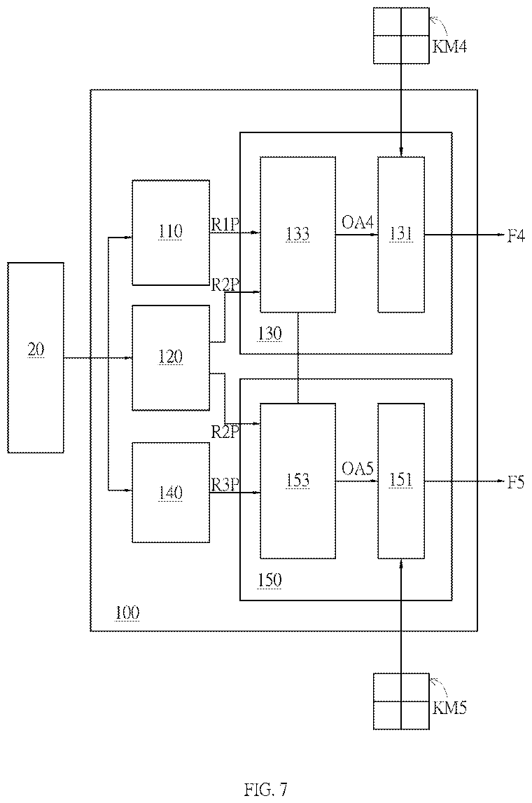

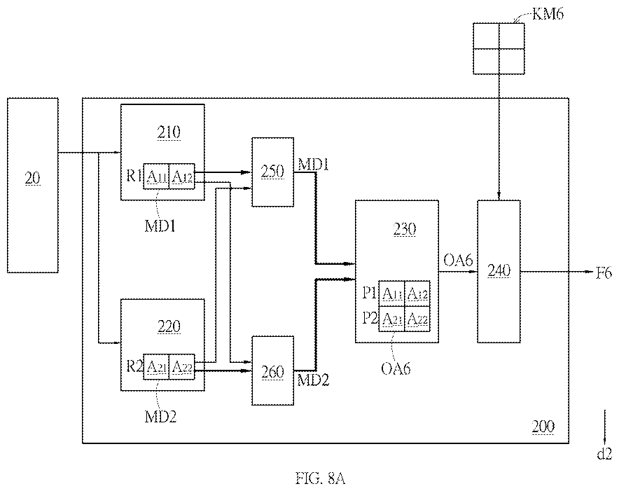

In an embodiment, the number of memory elements can be larger than 2. Each of the memory elements stores a part of the row data of the array data. For example, as shown in FIG. 6, the convolution operation module 100 comprises the third memory element 140 configured to store the third part R3P of the third row data R3 of the array data A. Wherein the third row data R3 is adjacent to the second row data R2 and the third part and the second part have the same amount of data. For example, each of the second row data R2 and the third row data R3 has m number of data, wherein m is a positive integer. Each of the second part R2P and the third part R3P has x number of data, wherein x is a positive integer larger than 1 and smaller than m. The integration element 133 of the first operation unit 130 reads the first part R1P, the second part R2P and the third part R3P and integrates the first part R1P, the second part R2P and the third part R3P into the third operation matrix OA3. The third operation matrix OA3 and the third kernel map KM3 can be 3×x matrixes. Preferably, the third operation matrix OA3 and the third kernel map KM3 are 3×3 square matrixes. In addition, in an embodiment, as shown in FIG. 7, the convolution operation module 100 further comprises the second operation unit 150 coupled to the second memory element 120 and the third memory element 140. Wherein the integration element 133 reads the first part R1P and the second part R2P and integrates the first part R1P and the second part R2P into the fourth operation matrix OA4. The integration element 153 of the second operation unit 150 reads the second part R2P and the third part R3P and integrates the second part R2P and the third part R3P into the fifth operation matrix OA5. It should be noted that the fourth operation matrix OA4 and the fifth operation matrix OA5 are 2×x matrixes. Preferably, the fourth operation matrix OA4 and the fifth operation matrix OA5 are 2×2 square matrixes. The first operation unit 150 performs the convolution operation on the fourth operation matrix OA4 and the fourth kernel map KM4 to derive the fourth feature value F4. Simultaneously, the second operation unit 150 performs the convolution operation on the fifth operation matrix OA5 and the fifth kernel map KM5 to derive the fifth feature value F5. By this means, the result amount of the convolution operation will be increased with less access to row data.

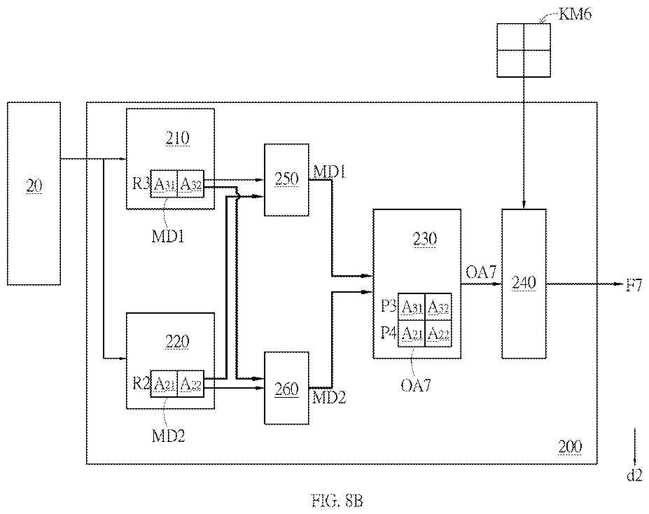

On the other hand, referring to FIG. 8A and FIG. 8B, the present invention provides the convolution operation module 200 comprising the first memory element 210, the second memory element 220, the integration element 230 and the first operation element 240. The first memory element 210 stores at least a part of the first row data R1 of the array data A as the first memory data MD1. The second memory element 220 stores at least a part of the second row data R2 of the array data A as the second memory data MD2. It should be noted that the present invention is not limited to the data amount of the row data saved in the memory element. For example, each of the first row data R1 and the second row data R2 has m number of data, wherein m is a positive integer. As such, the amount x of at least a part of the first row data R1 is an integer in the range between 1 and m. Wherein the second row data R2 is adjacent to the first row data R1 in array data A. The integration element 230 reads the first memory data MD1 and the second memory data MD2 and integrates the first memory data MD1 and the second memory data MD2 into the sixth operation matrix OA6. The first operation element 240 reads the sixth operation matrix OA6 and performs the convolution operation on the sixth operation matrix OA6 and the sixth kernel map KM6 to derive the sixth feature value F6. Next, refer to FIG. 8B. After the sixth feature value F6 is derived, the first memory element 210 stores at least a part of the third row data R3 of the array data A and updates the first memory data MD1. Wherein the third row data R3 is adjacent to the second row data R2 in the array data A. It should be noted that the present invention is not limited by the storage position of the third row data R3. In other words, at least a part of the third row data R3 not only can be stored in the first memory element 210 and be used to update the first memory data, but also can be stored in the second memory element 220 and be used to update the second memory data MD2. The integration element 230 reads the updated first memory data MD1 and the second memory data MD2 and integrates the updated first memory data MD1 and the second memory data MD2 into the seventh operation matrix OA7. The first operation element 240 performs the convolution operation on the seventh operation matrix OA7 and the sixth kernel map KM6 to derive the seventh feature value F7. Using the convolution operation module 200, when deriving feature values corresponding to different blocks in the data array A, the convolution operation module 200 only needs to access a row of data. Therefore, the time cost of the convolution operation can be reduced. However, the present invention is not limited by the number of rows of data accessed and the size of the kernel map.

In an embodiment, the convolution operation module 200 further comprises the first selector 250 and the second selector 260. The input ends of first selector 250 are coupled to the first memory element 210 and the second memory element 220 and the output end of first selector 250 is coupled to the integration element 230. The input ends of the second selector 260 are coupled to the first memory element 210 and the second memory element 220 and the output end of the second selector 260 is coupled to the integration element 230. The selectors 250 and 260 can be components which select input source as output, such as a multiplexer or switcher, preferably a multiplexer. More specifically, depending on the number of inputs, the selectors 250 and 260 can be 2-to-1 multiplexers. When deriving the sixth feature value F6 (shown in FIG. 8A), the first selector 250 outputs the first memory data MD1 to the integration element 230 as the first part P1 of the sixth operation matrix OA6 and the second selector 260 outputs the second memory data MD2 to the integration element 230 as the second part P2 of the sixth operation matrix OA6. Wherein the priority of the first part P1 is higher than the second part P2. In detail, the definition of the priority is, for example, the sequence order of the first part P1 and the second part P2 in the sixth operation matrix OA6. When deriving the seventh feature value F7, the first selector 250 outputs the second memory data MD2 to the integration element 230 as the third part P3 of the seventh operation matrix OA7 and the second selector 260 outputs the first memory data MD1 to the integration element 230 as the fourth part P4 of the seventh operation matrix OA7. Wherein the priority of the third part P3 is higher than the priority of the fourth part P4.

Similar to the first convolution operation module 100, the second convolution operation module 200 can be configured to include a plurality of operation elements for different kernel maps. For example, the second convolution operation module 200 comprises at least two operation elements. Each of the operation elements reads the operation matrix integrated by the integration element 230 and performs the convolution operation on the operation matrix and different kernel maps to derive corresponding feature values. In other words, the operation elements can simultaneously perform convolution operation on one operation matrix and different kernel maps. Simultaneously performing convolution operation can mean working under the same clock, but not limited thereto.

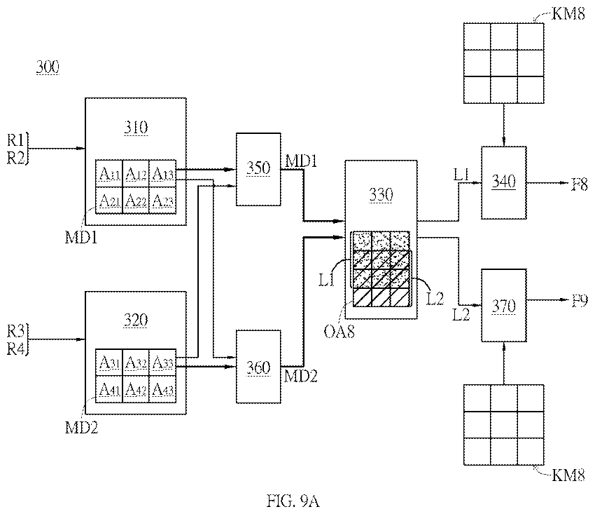

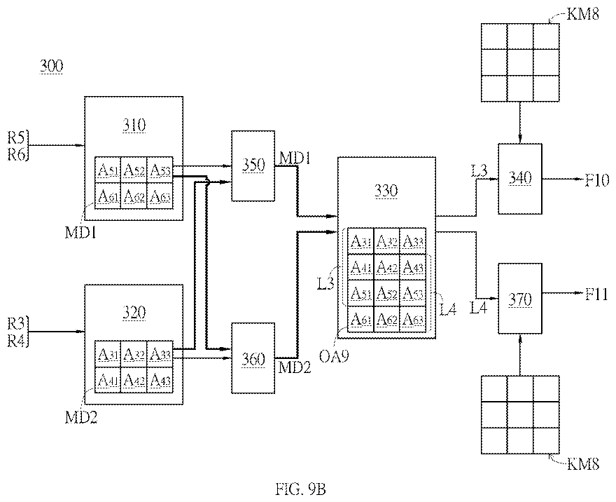

Refer to FIG. 9A. In an embodiment, the third convolution operation module 300 comprises the first memory element 310, the second memory element 320, the first selector 350, the second selector 360, the integration element 330, the first operation element 340 and the second operation element 370. The first memory element 310 stores at least a part of the first row data R1 and at least a part of the second row data R2 of the array data A as the first memory data MD1. The second memory element 320 stores at least a part of third row data R3 and at least a part of fourth row data R4 of the array data A as the second memory data MD2. Preferably, at least a part of the first row data R1 has 3 data A₁₁-A₁₃. The input ends of the first selector 350 are respectively coupled to the first memory element 310 and the second memory element 320 and the output end of the first selector 350 is coupled to the integration element 330. The input ends of the second selector 320 are respectively coupled to the first memory element 310 and the second memory element 320 and the output end of the second selector 320 is coupled to the integration element 330. The first operation element 340 and the second operation element 370 are respectively coupled to the integration element 330.

When deriving the eighth feature value F8 and ninth feature value F9, the first selector 350 outputs the first memory data MD1 and the second selector 360 outputs the second memory data MD2. The integration element 330 will depend on the order of the first selector 350 and the order of the second selector 360 to integrate data. In the embodiment, the priority of the first selector 350 is higher than the priority of the second selector 360. The integration element 330 integrates the first memory data MD1 and the second memory data MD2 into the eighth operation matrix OA8. More specifically, the eighth operation matrix OA8 is a 4×3 matrix. The first operation element 340 reads the first sub-matrix S1 of the eighth operation matrix OA8 and performs the convolution operation on the first sub-matrix S1 and the eighth kernel map KM8 to derive the eighth feature value F8. Simultaneously, the second operation element 370 reads the second sub-matrix S2 of the eighth operation matrix OA8 and performs the convolution operation on the second sub-matrix S2 and the eighth kernel map KM8 to derive the ninth feature value F9.

As shown in FIG. 9B, after the eighth feature value F8 and the ninth feature value F9 are derived, the first memory element 310 stores at least a part of the fifth row data R5 and at least a part of the sixth row data R6 and uses at least a part of the fifth row data R5 and at least a part of the sixth row data R6 to update the first memory data MD1. When deriving the feature value, the first selector 350 outputs the second memory data MD2 and the second selector 360 outputs the first memory data MD1. In other words, the first selector 350 outputs at least a part of the third row data R3 and at least a part of fourth row data R4 which are stored in the second memory element 320. The second selector 360 outputs at least a part of the fifth row data R5 and at least a part of sixth row data R6 which are stored in the first memory element 310. The integration element 330 integrates at least a part of the third row data R3, at least a part of fourth row data R4, at least a part of the fifth row data R5 and at least a part of sixth row data R6 into the ninth operation matrix OA9. The first operation element 340 reads the third sub-matrix L3 of the ninth operation matrix OA9 and performs the convolution operation on the third sub-matrix L3 and the eighth kernel map KM8 to derive the tenth feature value F10. Simultaneously, the second operation element 370 reads the fourth sub-matrix L4 of the ninth operation matrix OA9 and performs the convolution operation on the fourth sub-matrix L4 and eighth kernel map KM8 to derive the eleventh feature value F11.

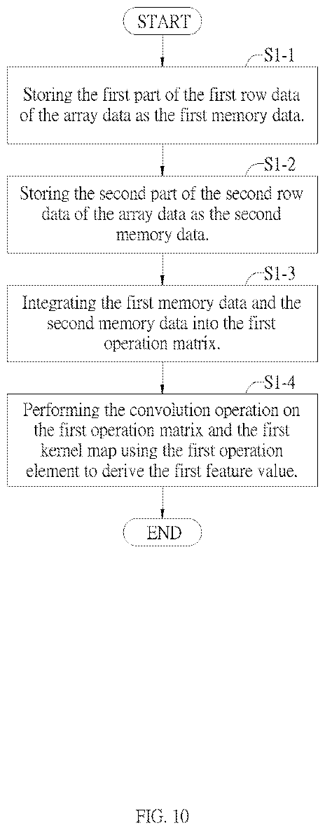

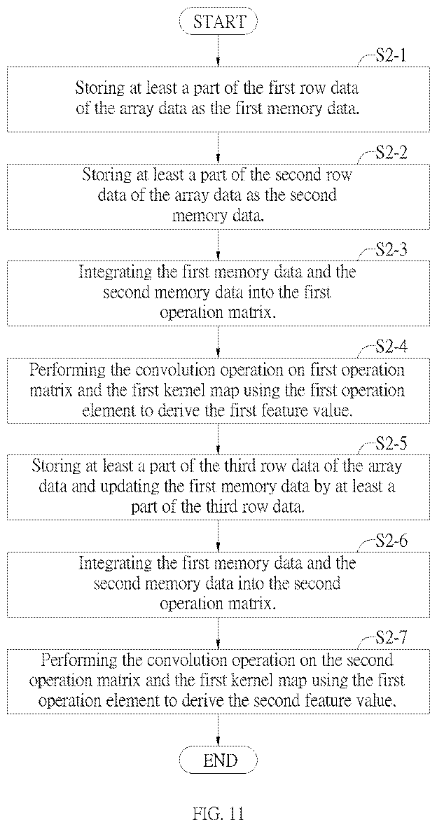

In an embodiment, as shown in FIG. 10, the convolution operation method comprises: step S1-1, storing the first part of the first row data of the array data as the first memory data; step S1-2, storing the second part of the second row data of the array data as the second memory data, wherein the second row data is adjacent to the first row data in the array data and the first part and the second part have the same amount of data. It should be noted that the step S1-1 an the step S1-2 can be accessed at the same time; step S1-3, reading the first memory data and the second memory data and integrating the first memory data and the second memory data into the first operation matrix, wherein the first operation matrix is preferably a square matrix; and step S1-4, performing the convolution operation on the first operation matrix and the first kernel map using the first operation element to derive the first feature value. When accessing the step S1-4, another feature value corresponding to the second kernel map can be derived using the second operation unit to perform the convolution operation on the first operation matrix and the second kernel map. After finished the step S1-4, adjust the contents stored in the first memory data and the second memory data according to the blocks in the array data that has not been performed the convolution operation to accomplish all the convolution operations of the blocks in the array data to derive the feature matrix.

In an embodiment, as shown in FIG. 11, the convolution operation method comprises: Step S2-1: storing at least a part of the first row data of the array data as the first memory data. Step S2-2; storing at least a part of the second row data of the array data as the second memory data, wherein the second row data is adjacent to the first row data in the array data. It should be noted that the step S2-1 and step S2-2 can be accessed at the same time. The convolution operation method is not limited by the number of storing steps. The number of storing steps can be adjusted depending on the convolution size. Step S2-3: reading the first memory data and the second memory data and integrating the first memory data and the second memory data into the first operation matrix. Step S2-4: performing the convolution operation on first operation matrix and the first kernel map using the first operation element to derive the first feature value. When accessing the step S2-4, a feature value corresponding to the second kernel map can be derived using the second operation unit to perform the convolution operation on the first operation matrix and the second kernel map. Step S2-5: storing at least a part of the third row data of the array data and updating the first memory data by at least a part of the third row data. Wherein the third row data is adjacent to the second row data in the array data. Step S2-6: reading the first memory data and the second memory data and integrating the first memory data and the second memory data into the second operation matrix. When accessing the step S2-6, the priority of the second memory data is preferably higher than the priority of the first memory data. In an embodiment, the first memory data and the second memory data can be selected by a selector. The selector is exemplarily configured to adjust the priorities of the first memory data and the second memory data. Step S2-7: performing the convolution operation on the second operation matrix and the first kernel map using the first operation element to derive the second feature value. After the second feature value is derived, adjust the contents stored in the first memory data and the second memory data according to the blocks in the array data that has not been performed the convolution operation to accomplish all the convolution operations of the blocks in the array data to derive the feature matrix.

Although the present invention discloses the aforementioned embodiments, it is not intended to limit the invention. Any person who is skilled in the art in connection with the present invention can make any change or modification without departing from the spirit and scope of the present invention. Therefore, the scope of protection of the present invention should be determined by the claims in the application.

What is claimed is:

1. A convolution operation module, comprising:
a first memory element configured to store a first part of a first row data of an array data;
a second memory element configured to store a second part of a second row data of the array data, wherein the second row data is adjacent to the first row data in the array data, and the first part and the second part have a same amount of data; and
a first operation unit coupled to the first memory element and the second memory element, wherein the first operation unit integrates the first part and the second part into a first operation matrix, wherein the first operation unit performs a convolution operation on the first operation matrix and a first kernel map to derive a first feature value.

2. The convolution operation module of claim 1, wherein the first operation unit comprises:
an integration element coupled to the first memory element and the second memory element, wherein the integration element is configured to integrate the first part and the second part to generate the first operation matrix; and
a first operation element coupled to the integration element, wherein the first operation element is configured to perform the convolution operation.

3. The convolution operation module of claim 2, further comprising a second operation element coupled to the integration element, wherein the second operation element performs the convolution operation on the first operation matrix and a second kernel map to derive a second feature value.

4. The convolution operation module of claim 1, further comprising:
a third memory element configured to store a third part of a third row data of the array data, wherein the third row data is adjacent to the second row data and the second part and the third part have a same amount of data; and
a second operation unit coupled to the second memory element and the third memory element, wherein the second operation unit integrates the second part and the third part into a second operation matrix, wherein the second operation unit performs the convolution operation on the second operation matrix and the first kernel map to derive a third feature value.

5. The convolution operation module of claim 1, wherein the first operation matrix is a square matrix.

6. A convolution operation module, comprising:
a first memory element configured to store at least a part of a first row data of a array data as a first memory data;
a second memory element configured to store at least a part of a second row data of the array data as a second memory data, wherein the second row data is adjacent to the first row data in the array data;
an integration element configured to integrate the first memory data and the second memory data into a first operation matrix; and
a first operation element configured to perform a convolution operation on the first operation matrix and a first kernel map to derive a first feature value;
wherein after the first feature value is derived, the first memory element stores at least a part of a third row data of the array data and updates the first memory data, wherein the third row data is adjacent to the second row data in the array data; the integration element integrates the updated first memory data and the second memory data into a second operation matrix, and the first operation element performs the convolution operation on the second operation matrix and the first kernel map to derive a second feature value.

7. The convolution operation module of claim 6, further comprising:
a first selector having input ends coupled to the first memory element and the second memory element and an output end coupled to the integration element; and
a second selector having input ends coupled to the first memory element and the second memory element and an output end coupled to the integration element,
when performing the convolution operation to derive the first feature value, the first selector outputs the first memory data to the integration element as a first part of the first operation matrix, and the second selector outputs the second memory data to the integration element as a second part of the first operation matrix, wherein the first part has priority over the second part;
when performing the convolution operation to derive the second feature value, the first selector outputs the second memory data to the integration element as a third part of the second operation matrix and the second selector outputs the first memory data to the integration element as a fourth part of the second operation matrix, wherein the third part has priority over the fourth part.

8. The convolution operation module of claim 6, further comprising a second operation element configured to load the first operation matrix and to perform the convolution operation on the first operation matrix and a second kernel map to derive a third feature value.

9. The convolution operation module of claim 6, wherein the first operation matrix is a square matrix.

10. A convolutional neural network, comprising:
a convolution operation module, comprising:
a first memory element configured to store a first part of a first row data of an array data;
a second memory element configured to store a second part of a second row date of the array data, wherein the second row data is adjacent to the first row data in the array data and the amount of the first part is equal to the amount of the second part; and
a first operation unit coupled to the first memory element and the second memory element, wherein the first operation unit loads the first part and the second part and is the first part and the second part to a first operation matrix, wherein the first operation unit performs a convolution operation on the first operation matrix and a first kernel map to derive a first feature value;
a pooling module coupled to the convolution operation module; and
a fully connected module coupled to the pooling module.

11. A convolutional neural network, comprising:
a convolution operation module, comprising:
a first memory element configured to store at least a part of a first row data of a array data as a first memory data;
a second memory element configured to store at least a part of a second row data of the array data as a second memory data, wherein the second row data is adjacent to the first row data in the array data;
an integration element configured to load the first memory data and the second memory data and integrate the first memory data and the second memory data into a first operation matrix; and
a first operation element configured to load the first operation matrix and to perform a convolution operation on the first operation matrix and a first kernel map to derive a first feature value;
after finished the convolution operation of the first feature value, the first memory element stores at least a part of a third row data of the array data and updates the first memory data, wherein the third row data is adjacent to the second row data in the array data, after the integration element loaded the updated first memory data and the second memory data and integrates the updated first memory data and the second memory data into a second operation matrix, the first operation element performs the convolution operation on the second operation matrix and the first kernel map to derive a second feature value;
a pooling module coupled to the convolution operation module; and
a fully connected module coupled to the pooling module.

12. A convolution operation method, comprising:
storing a first part of a first row of an array data as a first memory data;
storing a second part of a second row data of the array data as a second memory data, wherein the second row data is adjacent to the first row data in the array data and the first part and the second part have a same amount of data;
integrating the first memory data and the second memory data into a first operation matrix; and
performing a convolution operation on the first operation matrix and a first kernel map by a first operation element to derive a first feature value.

13. The convolution operation method of claim 12, further comprising:
performing the convolution operation on the first operation matrix and a second kernel map by a second operation element to derive a second feature value while performing the convolution operation by the first operation element.

14. The convolution operation method of claim 12, further comprising:
storing a third part of a third row data of the array data as a third memory data, wherein the third row data is adjacent to the second row data and the second part and the third part have a same amount of data;
integrating the second memory data and the third memory data to a second operation matrix; and
performing the convolution operation on the second operation matrix and the first kernel map by a third operation element to derive a third feature value.

15. The convolution operation method of claim 12, wherein the first operation matrix is a square matrix.

16. A convolution operation method, comprising:
storing at least a part of a first row data of an array data as a first memory data;
storing at least a part of a second row data of the array data as a second memory data, wherein the second row data is adjacent to the first row data in the array data;
loading the first memory data and the second memory data and integrating the first memory data and the second memory data to a first operation matrix;
performing a convolution operation on the first operation matrix and a first kernel map by a first operation element to derive a first feature value;
storing at least a part of a third row data of the array data and updating the first memory data by the part of a third row data of the array data, wherein the third row data is adjacent to the second row data in the array data;
integrating the first memory data and the second memory data into a second operation matrix; and
performing a convolution operation on the second operation matrix and the first kernel map by the first operation element to derive a second feature value.

17. The convolution operation method of claim 16, further comprising:
inputting the first memory data and the second memory data to a first selector;
inputting the first memory data and the second memory data to a second selector;
when calculating the first feature value, the first selector outputs the first memory data as a first part of the first operation matrix and the second selector outputs the second memory data as a second part of the first operation matrix, wherein the priority of the first part is higher than the priority of the second part; and
when calculating the second feature value, the first selector outputs the second memory data as a third part of the second operation matrix and the second selector outputs the first memory data as a fourth part of the second operation matrix, wherein the priority of the third part is higher than the priority of the fourth part.

18. The convolution operation method of claim 16, further comprising:
performing the convolution operation on the first operation matrix and a second kernel map by a second operation element while performing the convolution operation by the first operation element.

19. The convolution operation method of claim 16, wherein the first operation matrix is a square matrix.
